(19) United States
(12) Patent Application Publication
(10) Pub. No.: US 2026/0180129 A1
(43) Pub. Date: Jun. 25, 2026

(54) SEPARATOR FOR ELECTROCHEMICAL DEVICE, ELECTROCHEMICAL DEVICE INCLUDING THE SAME AND METHOD OF MANUFACTURING THE SAME

(71) Applicant: LG ENERGY SOLUTION, LTD., Seoul (KR)

(72) Inventors: Byeong Kyu LEE, Daejeon (KR); Seung Hyun LEE, Daejeon (KR); Yu Bae KIM, Daejeon (KR); Kyung Ryun KA, Daejeon (KR)

(73) Assignee: LG ENERGY SOLUTION, LTD., Seoul (KR)

(21) Appl. No.: 19/431,873

(22) Filed: Dec. 23, 2025

(30) Foreign Application Priority Data
Dec. 23, 2024 (KR) 10-2024-0193594
Dec. 15, 2025 (KR) 10-2025-0199452

(51) Int. Cl. H01M 50/451; H01M 10/052; H01M 50/403; H01M 50/417; H01M 50/42; H01M 50/434; H01M 50/489

(52) U.S. Cl. CPC H01M 50/451; H01M 50/403; H01M 50/417; H01M 50/42; H01M 50/434; H01M 50/489; H01M 10/052

(57) ABSTRACT

A separator for an electrochemical device of the present disclosure includes: a porous polymer substrate; and a coating layer that is provided on at least one surface of the porous polymer substrate, and includes a polymer binder and inorganic particles. The coating layer includes a first coating layer and a second coating layer formed on the first coating layer, and the packing density of the coating layer is about 1.70 g/cm³ or less.

### CROSS REFERENCES TO RELATED APPLICATIONS

This application is based on and claims priority from Korean Patent Application No. 10-2024-0193594, filed on Dec. 23, 2024 and No. 10-2025-0199452, filed on Dec. 15, 2025 with the Korean Intellectual Property Office, the disclosure of which is incorporated herein in its entirety by reference.

### TECHNICAL FIELD

The present disclosure relates to a separator for an electrochemical device, an electrochemical device including the same, and a manufacturing method thereof.

### BACKGROUND

An electrochemical device converts chemical energy into electrical energy by using electrochemical reactions. In recent years, lithium secondary batteries, which have a high energy density, a high voltage, and a long cycle life and can be used in various fields, are widely used.

A lithium secondary battery as an electrochemical device includes four key elements, which are a positive electrode, a negative electrode, a separator, and an electrolyte. These organically interact with each other while storing and releasing energy through repeated charging and discharging. For example, during charging and discharging processes, electricity is generated as lithium ions move through the electrolyte between the positive electrode and the negative electrode with the separator interposed therebetween. In general, the positive electrode and the negative electrode determine the performance of the battery, while the electrolyte and the separator determine the safety of the secondary battery.

### SUMMARY

The present disclosure provides a separator for an electrochemical device, an electrochemical device including the same, and a manufacturing method thereof, in which the coating layer structure of the separator may be controlled to minimize the air permeability increase rate.

Meanwhile, the problems to be solved by the present disclosure are not limited to the above-mentioned problems, and other unmentioned problems will be clearly understood by those skilled in the art from the following description.

In one embodiment of the present disclosure, a separator for an electrochemical device includes: a porous polymer substrate; and a coating layer provided on at least one surface of the porous polymer substrate and including a polymer binder and inorganic particles. The coating layer includes a first coating layer and a second coating layer formed on the first coating layer, and the coating layer has a packing density of 1.70 g/cm³ or less.

According to one embodiment of the present disclosure, the porous polymer substrate may have a thickness of about 8 μm to 15 μm.

According to one embodiment of the present disclosure, the packing density of the first coating layer may be about 1.80 g/cm³ or more.

According to one embodiment of the present disclosure, the first coating layer may have a thickness of about 0.5 μm to 2.5 μm, and the second coating layer may have a thickness of about 0.5 μm to 2.5 μm.

According to one embodiment of the present disclosure, the separator may have an air permeability of about 150% or less relative to an air permeability of the porous polymer substrate.

According to one embodiment of the present disclosure, the porous polymer substrate may have an air permeability of about 50 s/100 cc to 80 s/100 cc.

According to one embodiment of the present disclosure, the separator may have an air permeability of about 100 s/100 cc or less.

According to one embodiment of the present disclosure, a content of the inorganic particles may be about 80 parts by weight to 95 parts by weight based on 100 parts by weight of the coating layer.

According to one embodiment of the present disclosure, a content of the polymer binder may be about 1 part by weight to 10 parts by weight based on 100 parts by weight of the coating layer.

According to one embodiment of the present disclosure, the first coating layer and the second coating layer may be formed to have identical composition in terms of types and contents of the polymer binder and the inorganic particles.

In one embodiment of the present disclosure, a method of manufacturing a separator for an electrochemical device, includes providing a porous polymer substrate; forming a first coating layer by applying and drying a coating layer slurry to at least one surface of the porous polymer substrate; and forming a second coating layer by applying and drying the coating layer slurry to the first coating layer. The drying temperature is about 40° C. to 80° C.

According to one embodiment of the present disclosure, the drying temperature in the forming the first coating layer may be lower than the drying temperature in the forming the second coating layer.

According to one embodiment of the present disclosure, in the forming the first coating layer, the drying temperature may be about 40° C. to 50° C.

According to one embodiment of the present disclosure, during formation of the second coating layer, the drying temperature may be about 60° C. to 80° C.

In one embodiment of the present disclosure, an electrochemical device includes: a positive electrode; a negative electrode; and any one of the above-mentioned separators, which is interposed between the positive electrode and the negative electrode.

In the separator for an electrochemical device according to one embodiment of the present disclosure, the packing density of the coating layer may be controlled such that the air permeability increase rate may be minimized, thereby suppressing an increase in resistance of the electrochemical device.

In the manufacturing method of the separator for an electrochemical device according to one embodiment of the present disclosure, the drying conditions may be controlled after application of the coating layer slurry so as to minimize the air permeability increase rate and to suppress an increase in resistance of the electrochemical device.

In the electrochemical device according to one embodiment of the present disclosure, the air permeability increase rate of the separator including the coating layer may be minimized, thereby suppressing an increase in resistance of the electrochemical device.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic view illustrating a separator for an electrochemical device according to one embodiment of the present disclosure;

FIG. 2 is a schematic view illustrating a coating layer structure in Example 1 according to one embodiment of the present disclosure; and

FIG. 3 is a schematic view illustrating a coating layer structure in Comparative Example 3 according to one embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In this specification, when a certain part “includes” a certain component, this means that the certain part may further include other components rather than excluding other components unless specifically stated to the contrary.

In this specification, “A and/or B” means “A and B, or A or B”.

In this specification, “about,” “approximately,” and “substantially” are used to mean ranges of numerical values or degrees or approximations thereof, taking into account inherent manufacturing and material tolerances (e.g., ±5%).

In this specification, when one component is said to be provided “on” the other component, this does not exclude other components disposed between these, but means that other components may be further disposed unless specifically stated to the contrary.

In this specification, the characteristic of having pores means that the object includes a plurality of pores, and the pores are connected to each other to form a structure that allows gaseous and/or liquid fluid to pass from one side surface to the other side surface of the object.

Among components of the electrochemical device, a separator has a porous characteristic including a large number of pores, and serves as a porous ion-conducting barrier that blocks an electrical contact between a negative electrode and a positive electrode in an electrochemical device while allowing ions to pass. For example, the separator may include a polymer substrate having a porous structure, and serves to prevent an electrical short between the positive electrode and the negative electrode by separating two electrodes from each other while serving to allow an electrolyte and ions to pass therethrough. Although the separator itself does not participate in an electrochemical reaction, physical properties such as wettability to an electrolyte solution, porosity, and thermal shrinkage may affect the performance and safety of the electrochemical device.

In order to enhance these physical properties of the separator, a coating layer may be added to the porous polymer substrate, and then various methods, such as adding various substances to the coating layer, have been attempted to improve the properties of the coating layer. As an example, inorganic materials may be added to the coating layer in order to improve the mechanical strength of the separator, or inorganic materials or hydrates for improving flame retardancy and heat resistance of the polymer substrate may be added to the coating layer.

Within the coating layer, inorganic particles may be linked to other inorganic particles by a polymer binder to form an interstitial volume, and lithium ions may move through the interstitial volume. That is, the coating layer containing the polymer binder and the inorganic particles serves to prevent thermal shrinkage of the separator while serving to help lithium ions to move through the separator.

Meanwhile, when the coating layer containing the inorganic particles is provided, the inorganic particles may become an obstacle that blocks a movement passage of lithium ions, thereby increasing the resistance of a secondary battery. The present disclosure provides a separator, in which even when a coating layer containing inorganic particles is provided for the separator to improve battery stability, it is possible to minimize an increase in resistance.

Hereinafter, one embodiment of the present disclosure will be described in detail with reference to accompanying drawings. The drawings may be exaggerated, omitted, or schematically illustrated to describe or emphasize the contents of one embodiment of the present disclosure.

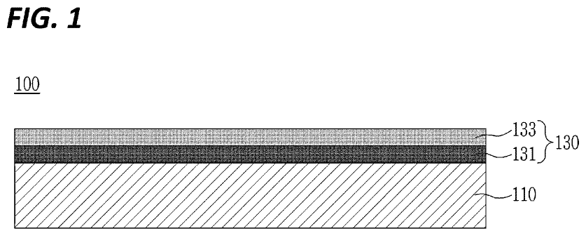

FIG. 1 is a schematic view illustrating a separator for an electrochemical device according to one embodiment of the present disclosure.

Hereinafter, the present disclosure will be described in more detail.

One embodiment of the present disclosure provides a separator 100 for an electrochemical device, which includes: a porous polymer substrate 110; and a coating layer 130 provided on at least one surface of the porous polymer substrate 110, and including a polymer binder and inorganic particles. The coating layer 130 includes a first coating layer 131 formed on the porous polymer substrate 110 and a second coating layer 133 formed on the first coating layer 131, and the packing density of the coating layer 130 is about 1.70 g/cm³ or less.

In the separator 100 for the electrochemical device according to one embodiment of the present disclosure, the packing density of the coating layer 130 may be controlled so that the air permeability increase rate may be minimized, thereby suppressing an increase in resistance of the electrochemical device. The air permeability increase rate may mean, for example, the rate of increase in air permeability relative to the air permeability of the porous polymer substrate 110 when the coating layer 130 is formed on the porous polymer substrate 110.

The separator 100 for the electrochemical device includes the porous polymer substrate 110. As described above, since the separator 100 for the electrochemical device includes the porous polymer substrate 110, it is possible to allow lithium ions to pass while blocking electrical contact between a positive electrode and a negative electrode of a lithium secondary battery, and a shutdown function may be implemented when the internal temperature of the battery abnormally rises. The shutdown function is a safety function that prevents a risk such as fire or explosion by stopping the operation of the battery at an appropriate temperature.

According to one embodiment of the present disclosure, the porous polymer substrate 110 may be manufactured using a polyolefin-based resin as a base resin. For example, the polyolefin-based resin may include at least one of polyethylene, polypropylene, and polypentene. A porous separator manufactured using the polyolefin-based resin as a base resin, for example, a separator having a large number of pores, may provide a shutdown function at an appropriate temperature.

According to one embodiment of the present disclosure, the weight average molecular weight of the polyolefin-based resin may be about 500,000 to 2,000,000. By adjusting the weight average molecular weight of the polyolefin-based resin within the above-described range, the compression resistance of the separator may be improved. Furthermore, when a mixture of different types of polyolefin-based resins is used or a separator is formed with a multi-layered structure made of different types of polyolefin-based resins, the weight average molecular weight of the polyolefin-based resin may be calculated by adding up the weight average molecular weights according to the respective content ratios of the polyolefin-based resins.

In the present specification, the weight average molecular weight (Mw) may be measured by gel permeation chromatography (GPC, PL GPC220, Agilent Technologies), and the measurement conditions may be set as follows.
Column: PL Olexis (Polymer Laboratories)
Solvent: TCB (Trichlorobenzene)
Flow rate: 1.0 ml/min
Sample Concentration: 1.0 mg/ml
Injection volume: 200 μl
Column Temperature: 160° C.
Detector: Agilent High Temperature RI detector
Standard: Polystyrene (corrected by a cubic function)

According to one embodiment of the present disclosure, in the method (wet method) of manufacturing the porous polymer substrate 110, a polyolefin-based resin may be mixed with a diluent at high temperatures to form a single phase, and phase-separation between the polymer material and the diluent may be induced in the cooling process, and then the diluent may be extracted to form pores and subsequently, stretching and heat-setting may be performed.

According to one embodiment of the present disclosure, in the manufacturing, the mixing ratio of the diluent, the stretching ratio, the heat-setting temperature, etc. may be easily controlled by a person skilled in the art so that the average pore size and the maximum pore size of the porous polymer substrate 110 fall within the ranges of the present disclosure.

According to one embodiment of the present disclosure, the thickness of the porous polymer substrate 110 may be about 8 μm to 15 μm. For example, the thickness of the porous polymer substrate 110 may be about 8 μm to 14 μm, 8 μm to 13 μm, 8 μm to 12 μm, 8 μm to 11 μm or 8 μm to 10 μm, or may be about 9.1 μm in one embodiment. By controlling the thickness of the porous polymer substrate 110 within the above-described range, the energy density of the battery may be improved.

According to one embodiment of the present disclosure, the thickness of the porous polymer substrate 110 may be measured by using a thickness measuring device (Mitutoyo corporation, VL-50S-B) through a contact-type measurement method.

According to one embodiment of the present disclosure, the air permeability of the porous polymer substrate 110 may be about 50 s/100 cc to 80 s/100 cc. For example, the air permeability of the porous polymer substrate 110 may be about 60 s/100 cc to 80 s/100 cc or 65 s/100 cc to 75 s/100 cc, or may be about 70 s/100 cc in one embodiment. By controlling the air permeability of the porous polymer substrate within the above-described range, it is possible to improve the ionic conductivity and durability and further to improve the resistance.

According to one embodiment of the present disclosure, as the air permeability, the time (s) required for 100 cc of air to pass through a separator (diameter: 28.6 mm, area: 645 mm²) is measured by using a Gurley densometer (Gurley, 4110N), and is expressed as an air permeation time. The Gurley used herein is a resistance against the flow of air and is measured by a Gurley densometer.

According to one embodiment of the present disclosure, the coating layer 130 is provided on at least one surface of the porous polymer substrate 110. As described above, since the separator 100 for the electrochemical device includes the coating layer 130 provided on at least one surface of the porous polymer substrate 110, it is possible to improve the heat resistance of the separator, to improve the mechanical properties, and to prevent the separator from shrinking at high temperatures and causing an electrical short-circuit in the electrode.

According to one embodiment of the present disclosure, the coating layer 130 includes the polymer binder and the inorganic particles. As described above, since the coating layer 130 includes the polymer binder and the inorganic particles, it is possible to improve the heat resistance of the separator, to improve the mechanical properties, to prevent the separator from shrinking at high temperatures and causing an electrical short-circuit in the electrode, and to form pores inside the coating layer 130.

According to one embodiment of the present disclosure, the coating layer 130 may be formed by the inorganic particles being bound by the polymer binder and accumulated within the layer. The pores within the coating layer 130 may be derived from the interstitial volumes that are empty spaces between the inorganic particles.

According to one embodiment of the present disclosure, the coating layer 130 may be a porous coating layer having a plurality of pores. As described above, since the coating layer 130 includes the plurality of pores, lithium ions are allowed to pass and then current is allowed to flow while a negative electrode and a positive electrode are physically blocked from each other.

According to one embodiment of the present disclosure, the inorganic particles that can be used for the coating layer 130 are not particularly limited as long as they are electrochemically stable. For example, the inorganic particles that can be used in one embodiment of the present disclosure are not particularly limited as long as they do not undergo oxidation and/or reduction reactions in the operating voltage range (e.g., 0 V to 5 V based on Li/Li⁺) in the application to the electrochemical device.

According to one embodiment of the present disclosure, examples of the inorganic particles may include BaTiO₃, Pb(Zr,Ti)O₃ (PZT), Pb₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, Al₂O₃, SiC, Al(OH)₃, TiO₂, aluminum peroxide, zinc tin hydroxide (ZnSn(OH)₆), tin-zinc oxide (Zn₂SnO₄ and ZnSnO₃), antimony trioxide (Sb₂O₃), antimony tetroxide (Sb₂O₄), and antimony pentoxide (Sb₂O₅), which may be used either alone or in combination of two or more thereof.

According to one embodiment of the present disclosure, the inorganic particle may be alumina (Al₂O₃). As described above, selecting alumina (Al₂O₃) as for the inorganic particle may improve the heat resistance of the separator. Meanwhile, since the inorganic particles are included in the coating layer 130, the inorganic particles may become an obstacle that blocks a movement passage of lithium ions, thereby causing an increase in resistance in the battery to be manufactured using the separator 100. However, as described below, through the adjustment of forming conditions of the coating layer 130, the air permeability increase rate may be minimized, and further an increase in resistance may be minimized.

According to one embodiment of the present disclosure, the average particle diameter (D50) of the inorganic particles is not particularly limited, but may fall within a range of about 0.1 μm to 1 μm so as to form the coating layer 130 with a uniform thickness and to obtain an appropriate porosity. For example, the average particle diameter (D50) of the inorganic particles may be about 0.2 μm to 0.9 μm, 0.3 μm to 0.8 μm, 0.4 μm to 0.7 μm, or 0.5 μm to 0.6 μm. By maintaining the average particle diameter (D50) within the above-described range, the dispersibility of the inorganic particles may be maintained within an appropriate range in a slurry prepared for producing the coating layer 130, and also the thickness of the coating layer 130 to be formed may be maintained within an appropriate range, thereby improving the uniformity of the coating layer 130.

In this specification, the “D50 particle diameter” refers to a particle diameter at the point of 50% in the cumulative distribution of the number of particles based on the particle diameter. The particle diameter may be measured by using a laser diffraction method. For example, measurement target powder is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The D50 particle diameter may be measured by calculating the particle diameter at the point of 50% in the cumulative distribution of the number of particles based on the particle diameter, in the measuring device.

According to one embodiment of the present disclosure, the content of the inorganic particles may be about 80 parts by weight to 95 parts by weight based on 100 parts by weight of the coating layer 130. For example, the content of the inorganic particles may be about 82 parts by weight to 93 parts by weight, 84 parts by weight to 91 parts by weight, 85 parts by weight to 90 parts by weight, or 86 parts by weight to 89 parts by weight based on 100 parts by weight of the coating layer 130. By controlling the content of the inorganic particles included in the coating layer 130 within the above-described range, it is possible to improve the heat resistance of the separator, thereby ensuring the safety of the battery.

According to one embodiment of the present disclosure, the polymer binder may be an acrylic binder. For example, the acrylic binder is a polymer containing a carboxylic acid ester as a repeating unit, and may be a (meth)acrylic acid ester or an acrylic-styrene copolymer.

According to one embodiment of the present disclosure, the (meth)acrylic acid ester may be at least one from, for example, methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, hexyl (meth)acrylate, cyclohexyl (meth)acrylate, 2-ethylhexyl (meth)acrylate, n-octyl (meth)acrylate, nonyl (meth)acrylate, decyl (meth)acrylate, hydroxymethyl (meth)acrylate, hydroxyethyl (meth)acrylate, ethyleneglycol (meth)acrylate, ethyleneglycol di(meth)acrylate, propyleneglycol di(meth)acrylate, trimethylolpropane tri(meth)acrylate, pentaerythritol tetra(meth)acrylate, dipentaerythritol hexa(meth)acrylate, allyl (meth)acrylate, or ethylene di(meth)acrylate. According to one embodiment, among these, the (meth)acrylic acid ester may be at least one selected from methyl (meth)acrylate, ethyl (meth)acrylate, and 2-ethylhexyl (meth)acrylate, or may be, for example, methyl (meth)acrylate.

According to one embodiment of the present disclosure, the acrylic-styrene copolymer may include an acrylic binder, and the acrylic binder may be a polyacrylate-based binder. For example, the binder may be at least one selected from styrene-butyl acrylate, styrene-butadiene rubber, nitrile-butadiene rubber, acrylonitrile-butadiene rubber, acrylonitrile-butadiene-styrene rubber, and acrylate-based polymer, or may be an acrylate-containing copolymer.

According to one embodiment of the present disclosure, the average particle diameter (D50) of the polymer binder is not particularly limited, but may be about 0.1 μm to 1 μm so as to form the coating layer 130 with a uniform thickness and to obtain an appropriate porosity. For example, the average particle diameter (D50) of the polymer binder may be about 0.1 μm to 0.8 μm, 0.1 μm to 0.6 μm, 0.1 μm to 0.4 μm, or 0.1 μm to 0.2 μm. When the average particle diameter (D50) falls within the above-described range, the air permeability increase rate may be suppressed. Also, by controlling the average particle diameter (D50) of the polymer binder within the above-described range, the dispersibility may be improved in a slurry prepared for producing the coating layer, thereby minimizing the air permeability increase rate.

According to one embodiment of the present disclosure, the content of the polymer binder may be about 1 part by weight to 10 parts by weight based on 100 parts by weight of the coating layer 130. Specifically, the content of the polymer binder may be 1 part by weight to 9 parts by weight, 2 parts by weight to 8 parts by weight, 2 parts by weight to 7 parts by weight, 3 parts by weight to 7 parts by weight, 4 parts by weight to 7 parts by weight, 5 parts by weight to 7 parts by weight, or 6 parts by weight to 7 parts by weight based on 100 parts by weight of the coating layer 130. When the content of the binder falls within the above-described range, the air permeability increase rate may be suppressed from increasing. By controlling the content of the polymer binder within the above-described range, it is possible to improve the binding force with the inorganic particles and to improve the binding force between the separator and the electrode, thereby improving the battery performance. Then, the air permeability increase rate may be minimized.

According to one embodiment of the present disclosure, the coating layer 130 may further include a surfactant besides the polymer binder and the inorganic particles. For example, the surfactant may be added to further facilitate casting of a coating layer composition. The surfactant may include a silicone-based surfactant. According to one embodiment, as for the surfactant, a polyether-modified siloxane-based surfactant may be used. When this is included, the coating of the coating layer composition may be performed with a more uniform thickness.

The polyether-modified siloxane-based surfactant is a surfactant that includes a polyether chain at the end and/or the side chain of a polysiloxane main chain. For example, the polyether-modified siloxane-based surfactant may include a polyethylene oxide group and/or a polypropylene oxide group.

As for such a polyether-modified siloxane-based surfactant, commercially available materials may be used. For example, at least one selected from BYK-345, BYK-346, BYK-347, BYK-348, BYK-349, BYK-3450, BYK-3455, BYK-3456, BYK-3560, BYK-3565, and BYK-3760 may be used.

According to one embodiment of the present disclosure, the content of the surfactant may be about 1 part by weight to 10 parts by weight based on 100 parts by weight of the coating layer. For example, the content of the surfactant may be about 1 part by weight to 9 parts by weight, 2 parts by weight to 8 parts by weight, 2 parts by weight to 7 parts by weight, 3 parts by weight to 7 parts by weight, 4 parts by weight to 7 parts by weight, 5 parts by weight to 7 parts by weight, or 6 parts by weight to 7 parts by weight based on 100 parts by weight of the coating layer 130. By controlling the content of the surfactant within the above-described range, it is possible to ensure the coating property improving effect of the coating layer.

According to one embodiment of the present disclosure, the solvent may be used without limitation in its composition as long as it allows the above-described components to be dissolved. For example, the solvent may be used either alone or in combination of two or more selected from water, ethanol, ethyleneglycol, diethyleneglycol, triethyleneglycol, 1,4-butanediol, propyleneglycol, ethyleneglycolmonobutylether, propyleneglycolmonomethylether, propyleneglycolmonomethyletheracetate, methylethylketone, acetone, methylamylketone, cyclohexanone, cyclopentanone, diethyleneglycolmonomethylether, diethyleneglycolethylether, toluene, xylene, butyrolactone, carbitol, methylcellosolve acetate, and N,N-dimethylacetamide. According to one embodiment, as for the solvent, water may be used.

According to one embodiment of the present disclosure, the coating layers 130 may be provided on both surfaces of the porous polymer substrate 110. As described above, as the separator 100 for the electrochemical device includes the coating layers 130 provided on both surfaces of the porous polymer substrate 110, it is possible to improve the heat resistance of the separator 100, and to improve the mechanical properties.

According to one embodiment of the present disclosure, the coating layer 130 includes the first coating layer 131 formed on the porous polymer substrate 110, and the second coating layer 133 formed on the first coating layer 131. For example, for the coating layer 130, the first coating layer 131 may be formed on the porous polymer substrate 110, and then the second coating layer 133 may be formed. As described above, as the coating layer 130 includes the first coating layer 131 and the second coating layer 133 formed on the first coating layer 131, it is possible to reduce the air permeability increase rate of the separator 100 according to the respective formation conditions of the first coating layer 131 and the second coating layer 133.

According to one embodiment of the present disclosure, the first coating layer 131 and the second coating layer 133 may be formed to have the same compositions in terms of the types and contents of the polymer binder and inorganic particles. For example, for the first coating layer 131 and the second coating layer 133, the first coating layer may be formed by applying a coating layer slurry to the porous polymer substrate 110 once, and then the second coating layer 133 may be formed by applying the same coating layer slurry to the first coating layer 131 once again. Meanwhile, even when the first coating layer 131 and the second coating layer 133 are formed to have the same compositions in terms of the types and contents of the polymer binder and inorganic particles, due to a difference in the forming process between the first coating layer 131 and the second coating layer 133, the coating layers may differ in their structures and physical properties according to the formation conditions. As described above, even when the first coating layer 131 and the second coating layer 133 are formed to have the same composition in terms of the types and contents of the polymer binder and inorganic particles, the structure of the coating layer 130 may be adjusted by varying the forming condition for the forming process, so that it is possible to suppress the air permeability of the separator 100 from increasing and also further to suppress an increase in resistance of the separator 100.

According to one embodiment of the present disclosure, the packing density of the coating layer 130 is about 1.70 g/cm³ or less. For example, the packing density of the coating layer 130 may be about 1.50 g/cm³ to 1.70 g/cm³, 1.51 g/cm³ to 1.69 g/cm³, 1.51 g/cm³ to 1.68 g/cm³, 1.51 g/cm³ to 1.67 g/cm³, or 1.52 g/cm³ to 1.66 g/cm³. By controlling the packing density of the coating layer 130 within the above-described range, it is possible to reduce the air permeability increase rate of the separator 100.

According to one embodiment of the present disclosure, the packing density of the coating layer 130 may indicate the quantity of material included in a specific volume. For example, when a greater quantity of material is present in the same volume, the packing density of the coating layer 130 may be increased, and when a smaller quantity is present, the packing density may be decreased.

According to one embodiment of the present disclosure, the packing density of the first coating layer 131 may be about 1.80 g/cm³ or more. For example, the packing density of the first coating layer 131 may be about 1.81 g/cm³ to 1.89 g/cm³, 1.82 g/cm³ to 1.88 g/cm³, 1.83 g/cm³ to 1.88 g/cm³, 1.84 g/cm³ to 1.88 g/cm³, 1.85 g/cm³ to 1.88 g/cm³, or 1.86 g/cm³ to 1.88 g/cm³. By controlling the packing density of the first coating layer 131 within the above-described range, the heat resistance of the first coating layer 131 may be secured. Furthermore, by forming the second coating layer 133 on the first coating layer 131, it is possible to lower the packing density of the entire coating layer 130 and to reduce the air permeability increase rate of the separator 100.

According to one embodiment of the present disclosure, the thickness of the first coating layer 131 may be about 0.5 μm to 2.5 μm. For example, the thickness of the first coating layer 131 may be about 0.5 μm to 2 μm, 0.6 μm to 1.9 μm, 0.7 μm to 1.8 μm, 0.8 μm to 1.7 μm, 0.9 μm to 1.6 μm, 1 μm to 1.5 μm, 1 μm to 1.4 μm, 1 μm to 1.3 μm, or 1.1 μm to 1.3 μm. By maintaining the thickness within the above-described range, it is possible to suppress the air permeability increase rate, and to appropriately maintain the heat resistance in the coating layer 130.

According to one embodiment of the present disclosure, the thickness of the second coating layer 133 may be about 0.5 μm to 2.5 μm. For example, the thickness of the second coating layer 133 may be about 0.6 μm to 2.4 μm, 0.7 μm to 2.4 μm, 0.8 μm to 2.4 μm, 0.9 μm to 2.4 μm, 1 μm to 2.4 μm, 1.1 μm to 2.4 μm, or 1.2 μm to 2.4 μm. By maintaining the thickness within the above-described range, it is possible to suppress the air permeability increase rate, and to appropriately maintain the heat resistance in the coating layer 130.

In one embodiment of the present disclosure, the thickness of the coating layer 130 may be measured by employing a contact-type thickness measuring device. As for the contact-type thickness measuring device, for example, VL-50S-B of Mitutoyo corporation may be used.

According to one embodiment of the present disclosure, the air permeability of the separator 100 may be 150% or less relative to the air permeability of the porous polymer substrate 110. For example, the air permeability of the separator 100 may be about 100% to 150%, 100% to 148%, 100% to 146% 100% to 144% 100% to 142% 100% to 140% 105% to 140%, 110% to 140% 115% to 140% 120% to 140% 125% to 140% or 129% to 140% relative to the air permeability of the porous polymer substrate 110. By maintaining the air permeability within the above-described range, it is possible to suppress the resistance of the separator from being increased due to a blocking obstacle of a lithium ion movement passage.

According to one embodiment of the present disclosure, the air permeability of the separator 100 may be about 100 s/100 cc or less. For example, the air permeability of the separator 100 may be about 70 s/100 cc to 100 s/100 cc, 70 s/100 cc to 99 s/100 cc, 70 s/100 cc to 98 s/100 cc, 75 s/100 cc to 98 s/100 cc, 80 s/100 cc to 98 s/100 cc, 85 s/100 cc to 98 s/100 cc, or 90 s/100 cc to 98 s/100 cc. When the air permeability falls within the above-described range, it is possible to suppress the resistance from being increased due to an obstacle that blocks a movement passage of lithium ions, that is, inorganic particles contained in the coating layer.

One embodiment of the present disclosure includes a method of manufacturing the separator 100 for the electrochemical device. The method includes the steps of: providing the porous polymer substrate 110; forming the first coating layer 131 by applying a coating layer slurry to at least one surface of the porous polymer substrate 110 and drying the coating layer slurry; and forming the second coating layer 133 by applying the coating layer slurry to the first coating layer 131 and drying the coating layer slurry. The drying temperature is about 40° C. to 80° C.

In the manufacturing method of the separator for the electrochemical device according to one embodiment of the present disclosure, the drying conditions may be controlled after application of the coating layer slurry so as to minimize the air permeability increase rate of the separator 100 and to suppress an increase in resistance.

According to one embodiment of the present disclosure, for the formation of the coating layer 130, the polymer binder and the inorganic particles may be included and dispersed in water to prepare the coating layer slurry. Next, the first coating layer 131 may be formed by applying the coating layer slurry to one surface of the porous polymer substrate 110 and drying the coating layer slurry, and similarly, the second coating layer 133 may be formed by applying the coating layer slurry to the first coating layer 131 and drying the coating layer slurry.

According to one embodiment of the present disclosure, in the drying, the coating layer slurry applied to one surface of the porous polymer substrate 110 may be dried through movement in a heating zone, and thus the coating layer 130 may be formed. The porous polymer substrate to which the coating layer slurry has been applied is dried by being moved at a predetermined speed through a heating zone heated to a predetermined temperature, and thus the separator 100 including the coating layer 130 may be formed. For example, the heating temperature of the heating zone may be about 40° C. to 80° C. The porous polymer substrate 110 to which the coating layer slurry has been applied may be moved through the heating zone at a speed of about 5 m/min to 30 m/min.

According to one embodiment of the present disclosure, the drying temperature for formation of the first coating layer 131 may be lower than the drying temperature for formation of the second coating layer 133. As described above, when a temperature lower than the drying temperature for formation of the second coating layer 133 is selected as the drying temperature for formation of the first coating layer 131, it is possible to ensure the heat resistance characteristics of the coating layer during formation of the first coating layer 131, and to reduce the packing density of the separator during formation of the second coating layer 133, thereby reducing the air permeability increase rate of the separator. Accordingly, an increase in resistance may be suppressed.

According to one embodiment of the present disclosure, during formation of the first coating layer 131, the drying temperature may be about 40° C. to 50° C. For example, during formation of the first coating layer 131, the drying temperature may be about 41° C. to 49° C., 42° C. to 48° C., 43° C. to 47° C., or 44° C. to 46° C., or may be about 45° C. in one embodiment. By controlling the drying temperature for formation of the first coating layer 131 within the above-described range, it is possible to ensure the heat resistance characteristics of the coating layer 130 during formation of the first coating layer 131.

According to one embodiment of the present disclosure, during formation of the second coating layer 133, the drying temperature may be about 60° C. to 80° C. For example, during formation of the second coating layer 133, the drying temperature may be about 61° C. to 79° C., 62° C. to 78° C., 63° C. to 77° C., or 64° C. to 76° C., or may be about 70° C. in one embodiment. By controlling the drying temperature for formation of the second coating layer 133 within the above-described range, it is possible to reduce the packing density of the separator during formation of the second coating layer 133, and to reduce the air permeability increase rate of the separator, thereby suppressing an increase in resistance.

One embodiment of the present disclosure includes an electrochemical device that includes: a positive electrode; a negative electrode; and any one of the above-mentioned separators, which is interposed between the positive electrode and the negative electrode. In the electrochemical device according to one embodiment of the present disclosure, the contents overlapping with the description for the separator 100 for the electrochemical device will be omitted.

In the electrochemical device according to one embodiment of the present disclosure, it is possible to minimize the air permeability increase rate of the separator 100 including the coating layer 130, thereby suppressing an increase in resistance.

In one embodiment of the present disclosure, the electrochemical device is a device that converts chemical energy into electrical energy through an electrochemical reaction, and has a concept that encompasses a primary battery and a secondary battery. In this specification, the secondary battery is chargeable and dischargeable, and refers to a lithium secondary battery, a nickel-cadmium battery, a nickel-hydrogen battery, etc. The lithium secondary battery uses lithium ions as an ion conductor. Examples thereof may include a non-aqueous electrolyte secondary battery including a liquid electrolyte, a solid-state battery including a solid electrolyte, a lithium polymer battery including a gel polymer electrolyte, and a lithium metal battery using a lithium metal as a negative electrode, but are not limited to these.

According to one embodiment of the present disclosure, the positive electrode includes a positive electrode current collector and a positive electrode active material layer on at least one surface of the current collector. The positive electrode active material layer contains a positive electrode active material, a conductive material, and a binder resin. The positive electrode active material may include one selected from layered compounds such as lithium manganese composite oxide (LiMn₂O₄, LiMnO₂, etc.), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B, or Ga, x=0.01 to 0.3); lithium manganese composite oxide represented by a chemical formula LiMn₁₋ₓMₓO₂ (where M=Co, Ni, Fe, Cr, Zn, or Ta, x=0.01 to 0.1) or Li₂Mn₃MO₈ (where M=Fe, Co, Ni, Cu, or Zn); LiMn₂O₄ in which a part of Li in the chemical formula is substituted with an alkaline earth metal ion; a disulfide compound; and Fe₂(MoO₄)₃, or mixtures thereof.

According to one embodiment of the present disclosure, the negative electrode includes a negative electrode current collector and a negative electrode active material layer on at least one surface of the current collector. The negative electrode active material layer contains a negative electrode active material, a conductive material, and a binder resin. The negative electrode may include, as the negative electrode active material, one selected among lithium metal oxides; carbon such as non-graphitizable carbon or graphite-based carbon; metal composite oxides such as LixFe₂O₃ (0≤x≤1), LiₓWO₂(0≤x≤1), and SnₓMe₁₋ₓMe′_{y}Oz (Me: Mn, Fe, Pb, or Ge; Me′: Al, B, P, Si, elements belonging to groups 1, 2, and 3 of the periodic table, or halogen; 0≤x≤1; 1≤y≤3; and 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide, or mixtures thereof.

According to one embodiment of the present disclosure, the conductive material may be any one selected from the group including, for example, graphite, carbon black, carbon fiber or metal fiber, metal powder, conductive whiskers, conductive metal oxide, activated carbon, and polyphenylene derivatives, or a mixture of two or more thereof. For example, the conductive material may be one selected from natural graphite, artificial graphite, super-p, acetylene black, Ketjen black, channel black, furnace black, lamp black, thermal black, Denka black, aluminum powder, nickel powder, zinc oxide, potassium titanate, and titanium oxide, or a mixture of two or more thereof.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, or silver may be used.

According to one embodiment of the present disclosure, as for the binder resin, a polymer commonly used for electrodes in the art may be used. Non-limiting examples of this binder resin may include polyvinylidene fluoride-co-hexafluoropropylene, polyvinylidene fluoride-cotrichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetatepropionate, cyanoethylpullulan, cyanoethylpolyvinylalcohol, cyanoethylcellulose, cyanoethylsucrose, pullulan, and carboxymethyl cellulose, but are not limited thereto.

According to one embodiment of the present disclosure, a positive electrode slurry for preparing the positive electrode active material layer may contain a dispersant. The dispersant may be a pyrrolidone-based compound, and specifically may be N-methylpyrrolidone (ADC-01, LG Chemical).

According to one embodiment of the present disclosure, the electrochemical device may further include an electrolyte, and the electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B⁻ may include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethyl carbonate (DEC), dimethyl carbonate (DMC), dipropyl carbonate (DPC), dimethylsulfoxide, acetonitrile, dimethoxyethane, diethoxyethane, tetrahydrofuran, N-methyl-2-pyrrolidone (NMP), ethyl methyl carbonate (EMC), gamma butyrolactone, or a mixture thereof.

According to one embodiment of the present disclosure, a battery module including a battery including the electrochemical device as a unit cell, a battery pack including the battery module, and a device including the battery pack as a power source may be provided. Examples of the device may include: a power tool powered and driven by a battery motor; electric cars including an electric vehicle (EV), a hybrid electric vehicle (HEV), and a plug-in hybrid electric vehicle (PHEV); electric two-wheeled vehicles including an electric bicycle (E-bike), and an electric scooter (E-scooter); an electric golf cart; and a power storage system, but are not limited thereto.

Hereinafter, in order to describe the present disclosure in more detail, detailed descriptions will be made with reference to Examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### Example 1

### Manufacturing of Porous Polymer Substrate

A porous polymer substrate (the total thickness: 9.1 μm, and the air permeability: 70 s/100 cc) was manufactured by extruding polyethylene resin (weight average molecular weight: 1,500,000) through a wet method.

### Formation of Coating Layer

Al₂O₃(AES 11, Sumitomo) having a D50 particle diameter of 500 nm was prepared as inorganic particles. An acrylic copolymer (CSB-140, Toyo) having a D50 particle diameter of 150 nm was prepared as a polymer binder, and a silicone-based surfactant (BYK-348, BYK) was prepared.

The prepared inorganic particles, the polymer binder, and the surfactant were added to water at a weight ratio of 87.5:6.25:6.25, and then were dispersed to prepare a coating layer slurry.

In the first coating, the coating layer slurry was applied to one surface of the porous polymer substrate by a bar-coating method using a doctor blade.

The first coated porous polymer substrate was introduced into five heating zones under a temperature condition of 45° C., and was dried by being moved at a speed of 5 m/min to 30 m/min. Then, a first coating layer was formed with a thickness of 1.3 μm.

Next, in the second coating, the coating layer slurry was applied to the first coating layer by a bar-coating method using a doctor blade.

The second coated porous polymer substrate was introduced into the heating zone under a temperature condition of 70° C., and was dried by being moved at a speed of 5 m/min to 30 m/min. Then, a second coating layer was formed with a thickness of 2.4 μm. Here, a separator with a total thickness of 12.8 μm was manufactured.

### Example 2

A separator was manufactured in the same manner as in Example 1 except that in Example 1, the thickness of the first coating layer was 1.1 μm, the thickness of the second coating layer was 1.2 μm, and the total thickness was 11.4 μm.

### Comparative Example 1

A separator was manufactured in the same manner as Example 1 except that in Example 1, the thickness of the first coating layer was 1.8 μm, the thickness of the second coating layer was 2.5 μm, and the total thickness was 13.4 μm.

### Comparative Example 2

### Manufacturing of Porous Polymer Substrate

A porous polymer substrate (the total thickness: 9.1 μm, and the air permeability: 70 s/100 cc) was manufactured by extruding polyethylene resin (weight average molecular weight: 1,500,000) through a wet method.

### Formation of Coating Layer

Al₂O₃(AES 11, Sumitomo) having a D50 particle diameter of 500 nm was prepared as inorganic particles. An acrylic copolymer (CSB-140, Toyo) having a D50 particle diameter of 150 nm was prepared as a polymer binder, and a silicone-based surfactant (BYK-348, BYK) was prepared.

The prepared inorganic particles, the polymer binder, and the surfactant were added to water at a weight ratio of 87.5:6.25:6.25, and then were dispersed to prepare a coating layer slurry.

The coating layer slurry was applied to one surface of the porous polymer substrate by a bar-coating method using a doctor blade.

Next, the coated porous polymer substrate was introduced into five heating zones under temperature conditions of 40° C., 40° C., 50° C., 70° C., and 70° C., respectively, and was dried by being moved at a speed of 5 to 30 m/min. Then, a coating layer was formed with a thickness of 3.5 μm. Here, a separator with a total thickness of 12.6 μm was manufactured.

### Comparative Example 3

A separator was manufactured in the same manner as in Comparative Example 2, except that in Comparative Example 2, during formation of the coating layer, the drying conditions were changed as follows.

The coated porous polymer substrate was introduced into the heating zone under a temperature condition of 45° C., and was dried by being moved at a speed of 5 to 30 m/min. Then, a coating layer was formed with a thickness of 3.3 μm. Here, a separator with a total thickness of 12.4 μm was manufactured.

### Experimental Example

### Air Permeability Measurement

For the separators of Examples and Comparative Examples, as the air permeability, the time (s) required for 100 cc of air to pass through a separator (diameter: 28.6 mm, area: 645 mm²) was measured by using a Gurley densometer (Gurley, 4110N).

TABLE 1

| | | Example | Example | Comparative | Comparative | Comparative |
|---|---|---|---|---|---|---|
| | | 1 | 2 | Example 1 | Example 2 | Example 3 |
| Air permeability of | | 70 | 70 | 70 | 70 | 70 |
| substrate (s/100 cc) | | | | | | |
| Air | First | 83 | 83 | 90 | 110 | 126 |
| permeability of | layer | | | | | |
| separator | Second | 98 | 90 | 106 | | |
| (s/100 cc) | layer | | | | | |
| Air permeability increase | | 140 | 129 | 151 | 157 | 180 |
| rate (%) | | | | | | |
| Temperature | First | 45° C. | 45° C. | 45° C. | Low initial | 45° C. |
| condition for | layer | | | | temperature | |
| drying coating | Second | 70° C. | 70° C. | 70° C. | | |
| layer | layer | | | | | |
| Packing density | First | 1.86 | 1.88 | 1.87 | 1.71 | 1.84 |
| of coating layer | layer | | | | | |
| (g/cm³) | Total | 1.52 | 1.66 | 1.63 | | |
| Loading | First | 2.42 | 2.07 | 3.36 | 5.99 | 6.07 |
| amount of | layer | | | | | |
| coating layer | Second | 5.62 | 3.82 | 7.02 | | |
| (g/m²) | layer | | | | | |
| Coating layer | First | 1.3 | 1.1 | 1.8 | 3.5 | 3.3 |
| thickness (μm) | layer | | | | | |
| | Second | 2.4 | 1.2 | 2.5 | | |
| | layer | | | | | |

| | | | | | |
|---|---|---|---|---|---|
| Separator thickness (μm) | 12.8 | 11.4 | 13.4 | 12.6 | 12.4 |

According to Table 1 above, in Examples 1 and 2, during formation of the coating layer 130 of the separator 100, the packing densities of the first coating layer 131 and the second coating layer 133 were controlled so that the air permeability increase rate of the separator 100 formed with the coating layer 130 was minimized relative to the air permeability of the porous polymer substrate 110. Then, it can be found that the air permeability of the separator 100 was 100 s/100 cc or less.

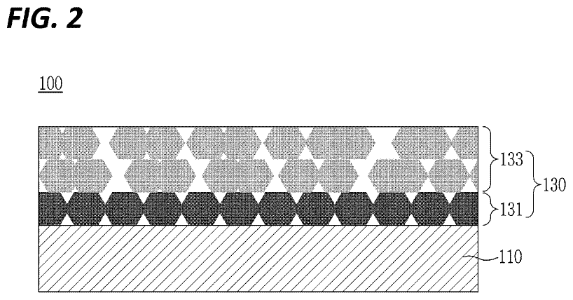

Also, according to FIG. 2, it can be found that in the first coating layer 131 of Example 1, since the slurry drying speed was slow at a low drying temperature, the inorganic particles in the first coating layer 131 were densely packed, and in the second coating layer 133, since the slurry drying speed was fast at a high drying temperature, the inorganic particles in the second coating layer 133 were formed with a relatively lower density than in the first coating layer 131.

In contrast, even though in Comparative Example 1, the drying temperature conditions for forming the coating layer 130 were the same as those in Examples, the thickness of the coating layer 130 was increased. Thus, it can be found that the air permeability increase rate of the separator 100 was increased relative to the air permeability of the porous polymer substrate 110.

Unlike in the forming conditions of the coating layer 130 in Examples, in those in Comparative Example 2, the second coating layer 133 was not formed, and a low initial temperature was set for the drying temperature conditions during formation of the coating layer 130 so that the drying was slowly performed. Thus, most of the inorganic particles sank and were densely packed and distributed. Then, it can be found that as a high temperature was subsequently set, the air permeability increase rate was increased due to high-temperature shrinkage. Also, it can be found that the packing density was increased compared to Examples.

Unlike in the forming conditions of the coating layer 130 in Examples, in those in Comparative Example 3, the second coating layer 133 was not formed, and a low drying temperature was maintained during formation of the coating layer 130 so that the drying was slowly performed. Thus, the inorganic particles sank and were densely packed and distributed, and then the air permeability increase rate of the separator 100 was increased. Accordingly, an increase in resistance may be predicted. Also, it can be found that the packing density was increased compared to Examples.

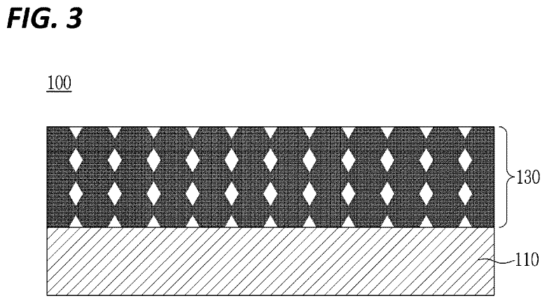

Also, according to FIG. 3, in Comparative Example 3, it can be found that since the slurry drying speed was slow at a low drying temperature during formation of the coating layer 130, inorganic particles were densely packed in the coating layer 130.

Therefore, in the separator 100 for the electrochemical device according to one embodiment of the present disclosure, the electrochemical device including the same, and the manufacturing method thereof, the structure of the coating layer 130 may be controlled so that an increase in the air permeability of the separator 100 can be controlled and further an increase in resistance of the separator 100 can be suppressed.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below. Therefore, the technical scope of the various embodiments of the present disclosure is not limited to that in the Detailed Description section above, and may be defined by the claims.

What is claimed is:

1. A separator for an electrochemical device, comprising:
a porous polymer substrate; and
a coating layer provided on at least one surface of the porous polymer substrate and including a polymer binder and inorganic particles,
wherein the coating layer includes a first coating layer and a second coating layer formed on the first coating layer, and
the coating layer has a packing density of 1.70 g/cm³ or less.

2. The separator for an electrochemical device according to claim 1, wherein the porous polymer substrate has a thickness of about 8 μm to 15 μm.

3. The separator for an electrochemical device according to claim 1, wherein the packing density of the first coating layer is 1.80 g/cm³ or more.

4. The separator for an electrochemical device according to claim 1, wherein the first coating layer has a thickness of 0.5 μm to 2.5 μm, and
the second coating layer has a thickness of 0.5 μm to 2.5 μm.

5. The separator for an electrochemical device according to claim 1, wherein the separator has an air permeability of 150% or less relative to an air permeability of the porous polymer substrate.

6. The separator for an electrochemical device according to claim 1, wherein the porous polymer substrate has an air permeability of 50 s/100 cc to 80 s/100 cc.

7. The separator for an electrochemical device according to claim 1, wherein the separator has an air permeability of 100 s/100 cc or less.

8. The separator for an electrochemical device according to claim 1, wherein a content of the inorganic particles is 80 parts by weight to 95 parts by weight based on 100 parts by weight of the coating layer.

9. The separator for an electrochemical device according to claim 1, wherein a content of the polymer binder is 1 part by weight to 10 parts by weight based on 100 parts by weight of the coating layer.

10. The separator for an electrochemical device according to claim 1, wherein the first coating layer and the second coating layer are formed to have identical composition in terms of types and contents of the polymer binder and the inorganic particles.

11. A method of manufacturing a separator for an electrochemical device, the method comprising:
providing a porous polymer substrate;
forming a first coating layer by applying and drying a coating-layer-forming slurry to at least one surface of the porous polymer substrate; and
forming a second coating layer by applying and drying the coating-layer-forming slurry to the first coating layer,
wherein a drying temperature is 40° C. to 80° C.

12. The method according to claim 11, wherein a drying temperature in the forming the first coating layer is lower than a drying temperature in the forming the second coating layer.

13. The method according to claim 12, wherein in the forming the first coating layer, the drying temperature is 40° C. to 50° C.

14. The method according to claim 12, wherein in the forming the second coating layer, the drying temperature is 60° C. to 80° C.

15. An electrochemical device comprising:
a positive electrode;
a negative electrode; and
the separator according to claim 1,
wherein the separator is interposed between the positive electrode and the negative electrode.
